(19) United States
(12) Patent Application Publication
(10) Pub. No.: US 2025/0378715 A1
(43) Pub. Date: Dec. 11, 2025

(54) MOBILE DEVICE BASED TELEMATIC FEATURE CONTROL USING VEHICLE TRIP START DETECTION

(71) Applicant: SFARA INC, Hoboken, NJ (US)

(72) Inventors: James Rocco TRICARICO II, Richmond, VA (US); Ari VALTANEN, Sunnyvale, CA (US); Steven SHERRY, Allendale, NJ (US); Erik GOLDMAN, Des Peres, MO (US); Sascha SIMON, Warwick, NY (US)

(21) Appl. No.: 19/229,463

(22) Filed: Jun. 5, 2025

Related U.S. Application Data
(60) Provisional application No. 63/658,483, filed on Jun. 11, 2024.

(51) Int. Cl. G07C 5/00; G07C 5/08; H04W 4/40; H04W 4/80; H04W 12/50

(52) U.S. Cl. CPC G07C 5/008; G07C 5/0808; H04W 4/40; H04W 4/80; H04W 12/50

(57) ABSTRACT

The method performed by a mobile device includes receiving, by a communication receiver of the mobile device over a communication channel, a system identifier that uniquely identifies a vehicle system of a vehicle, detecting a vehicle trip start condition based on a pre-defined association between the system identifier and the mobile device, based on detecting the vehicle trip start condition, operating the mobile device in a vehicle mode comprising activating at least one telematics feature, and detecting vehicle telematics data generated by a telematics data sensor.

### CROSS-REFERENCE TO RELATED APPLICATION

The present application is based on and claims the benefit of U.S. provisional patent application Ser. No. 63/658,483, filed Jun. 11, 2024, the content of which is hereby incorporated by reference in its entirety.

### BACKGROUND

Vehicle telematics includes technology for generating, transmitting, receiving, and/or storing data related to vehicle operations and/or driver behavior. Vehicle telematics technology has become integral to applications such as fleet management, automotive insurance, and vehicle safety systems, such as crash detection system. Telematics systems often utilize sensors, communication modules, and data processing algorithms to monitor events such as vehicle location, speed, and mechanical status. For example, data from a vehicle's Control Area Network (CAN) bus, specified in the OBD-II diagnostics standard, can be used to detect critical events like airbag deployment, which may indicate a crash. Embedded telematics systems can then initiate emergency protocols, such as contacting a telematics service provider (TSP) or dispatching assistance to the accident location. These systems also enable usage-based insurance (UBI) models, which assess driver risk profiles based on driving behavior, offering discounts to safer drivers and higher premiums for riskier ones.

The discussion above is merely provided for general background information and is not intended to be used as an aid in determining the scope of the claimed subject matter.

### SUMMARY

The method performed by a mobile device includes receiving, by a communication receiver of the mobile device over a communication channel, a system identifier that uniquely identifies a vehicle system of a vehicle, detecting a vehicle trip start condition based on a pre-defined association between the system identifier and the mobile device, based on detecting the vehicle trip start condition, operating the mobile device in a vehicle mode comprising activating at least one telematics feature, and detecting vehicle telematics data generated by a telematics data sensor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates a vehicle telematics system in a vehicle environment, in one example.

FIG. 2 is a block diagram of a vehicle telematics system, in one example.

FIG. 3 is a block diagram of a mode determination system, in one example.

FIG. 4-1 illustrates one example of a user interface display for generating a vehicle association record.

FIG. 4-2 illustrates one example of a user interface display for setting up a new vehicle in a vehicle association record.

FIG. 4-3 illustrates a data structure storing vehicle association records, in one example.

FIGS. 5-1 and 5-2 (collectively referred to as FIG. 5) provide a flow diagram illustrating operation of a mode determination system, in one example.

FIG. 6 shows one example of the system illustrated in FIG. 1, deployed in a remote server environment.

FIG. 7 shows an example of a mobile device that can be used in the architectures shown in the previous Figures.

FIG. 8 shows an example of a mobile device that can be used in the architectures shown in the previous Figures.

FIG. 9 shows an example of a mobile device that can be used in the architectures shown in the previous Figures.

FIG. 10 is a block diagram showing one example of a computing environment that can be used in the architectures shown in the previous Figures.

While the above-identified figures set forth one or more examples of the disclosed subject matter, other examples are also contemplated, as noted in the disclosure. In all cases, this disclosure presents the disclosed subject matter by way of representation and not limitation. It should be understood that numerous other modifications and examples can be devised by those skilled in the art which fall within the scope and spirit of the principles of this disclosure.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, vehicle telematics systems are useful for obtaining, processing, storing, and/or transmitting data related to vehicle operations and driver behavior. Fleet management applications, for example, leverage vehicle telematics to optimize the operation, monitoring, and maintenance of vehicle fleets. By utilizing data collected from telematics systems, fleet managers can track vehicle locations in real-time, monitor driver behavior, and assess vehicle health to ensure operational efficiency and safety. For instance, telematics systems can detect harsh braking, speeding, or excessive idling, allowing fleet managers to identify and address unsafe or inefficient driving practices. Additionally, telematics data can be used to schedule preventative maintenance based on vehicle usage patterns, reducing downtime and repair costs. Fleet management applications also play a critical role in detecting and responding to incidents such as vehicle crashes, providing immediate alerts and detailed data for analysis. Furthermore, these applications can help mitigate fuel fraud (e.g., when an individual driver uses, or gives the card to another person, to procure fuel for extra or unintended vehicles) by correlating fuel card transactions with vehicle locations and driver identities, ensuring accountability and reducing financial losses. By integrating telematics technology, fleet management applications can enhance productivity, improve safety, and reduce operational costs.

Insurance telematics applications, for example, utilize vehicle data to transform traditional automotive insurance models into dynamic, usage-based frameworks. By analyzing driving behavior, such as speed, acceleration, braking patterns, and trip frequency, telematics systems enable insurers to assess individual risk profiles with greater precision. This allows for personalized premiums, offering discounts to safer drivers while assigning higher rates to riskier ones. Additionally, telematics systems facilitate first notice of loss (FNOL) capabilities by detecting collisions in real-time and automatically notifying insurers, streamlining the claims process and reducing administrative delays. Advanced crash detection features can also verify the severity of impacts, ensuring accurate claims assessments and minimizing fraud. These applications not only improve the efficiency of claims handling but also enhance customer satisfaction by expediting resolutions. As repair costs and premiums continue to rise, insurance telematics provides a cost-effective solution for insurers to better manage risk, reduce expenses, and offer competitive pricing to policyholders.

Consumer vehicle applications, for example, focus on enhancing driver safety, convenience, and overall vehicle performance. Telematics systems can send real-time crash alerts to emergency services and designated family members, ensuring rapid response in the event of an accident. These systems can also monitor driving behavior, providing feedback to drivers to encourage safer practices, such as reducing speeding, harsh braking, or distracted driving. Additionally, telematics-enabled navigation systems offer real-time traffic updates and route optimization, improving travel efficiency and reducing fuel consumption. For electric vehicles, telematics can assist in monitoring battery health and locating nearby charging stations, enhancing the user experience. Furthermore, consumer telematics applications can integrate with smartphone platforms to provide seamless connectivity, enabling features such as remote vehicle diagnostics, keyless entry, and climate control adjustments. By leveraging telematics technology, consumer vehicle applications deliver a safer, smarter, and more connected driving experience.

Despite their benefits, some telematics systems face challenges such as high costs, lack of standardization across vehicle models, and reliance on proprietary hardware. These solutions can struggle with network shutdowns and limited accident detection capabilities. While over-the-top solutions, such as on-board diagnostic program dongles, inherently address several of these drawbacks, operational challenges, such as hardware installation costs and data transport (from device to server/cloud) requirements, impede widespread adoption. Within this context, smartphone-based solutions provide a cost-effective alternative, leveraging the advanced sensors and communication capabilities of mobile devices to infer vehicle-related events.

One important aspect to many vehicle telematics systems pertains to how and when a trip start is detected, such that appropriate telematics features are promptly enabled. For instance, a vehicle or “drive” mode can be enabled upon detection of a trip start condition. Once in the vehicle mode, the system is configured to interpret certain detected characteristics as indicating a vehicle crash. Some current solutions detect trip starts too slowly, leaving users unnecessarily exposed. For instance, one estimate indicates that up to twenty percent of vehicle accidents occur in parking lots, up to twenty five percent occur within the first three minutes of a trip, and up to twenty three percent occur within the first mile of a trip.

However, these systems often struggle with delayed trip start detection, which can negatively affect the crash detection and other telematic applications. For instance, many smartphone-based solutions rely on global positioning system (GPS) based methods alone to detect trip starts, which can result in late activation of crash detection systems, leaving users exposed during the initial moments of a trip.

One “manual” approach to entering vehicle mode relies on the operator to manual active the vehicle mode, such as by actively engaging a specific application or feature on their mobile device before starting a trip. For example, a driver may need to launch a drive mode application or toggle a setting to enable telematics features such as crash detection or trip logging. While this approach can eliminate the need for additional hardware, it is highly dependent on user compliance and is prone to human error. If the user forgets or chooses not to activate the vehicle mode, some or all telematics functions may remain disabled, leaving the driver unprotected during the trip. Additionally, manual activation can be inconvenient, particularly for users who frequently switch between driving and non-driving activities or drive multiple different vehicles. This reliance on user intervention undermines the reliability of telematics systems, as it introduces delays in activating safety features and increases the likelihood of missed events, such as crashes or unsafe driving behaviors, during the initial moments of a trip.

Further, an “automatic” approach to entering a vehicle mode can also be problematic. First, in some instances, automatic on/off for the vehicle mode may use only the GPS sensor to determine when a smartphone is in a moving vehicle, which can be problematic for a number of reasons. First, the speed threshold of the application is arbitrary, meaning that drive mode will not be detected/engaged at less than twenty five miles per hour (MPH), or some other threshold. If the vehicle is stopped in traffic or at a traffic signal, for example, then the drive mode application may inadvertently terminate. Second, and perhaps more importantly, the drive mode application requires that the smartphone's GPS functionality be turned on at all times. Because the use of a smartphone's GPS sensor is extremely demanding to the battery resources of a smartphone, this requirement severely undermines the usefulness of the drive mode application. Thirdly this method may not differentiate between the type of vehicle that the phone is in, e.g. a bus, a taxi or a train and therefore allows no correlation between the owner of the phone and her driving situation.

Some approaches have tried to solve some of these problems with hybrid models such that there is a special hardware device that gets mounted into the car and that communicates with the smartphone. However, as stated above, these approaches suffer from the same issues that other dongle solutions suffer from, including, but not limited to, logistics, cost and ease of use.

If no extra dongle or beacon technology is installed and connected in the vehicle, some current smartphone software relies on crude methods to detect trip starts in vehicles for the activation of the sensors in the smartphone. One approach utilizes detection of a significant change in location via Global Positioning System (GPS) sensors to detect a trip start. This type of system is often referred to as a Geo-Brake. In a rest state, the sensors that infer events are not active in order to conserve battery power. Upon detection of the significant change (e.g., one hundred to one thousand ft of distance depending on the location of the smartphone in relation to the signal of GPS satellites), the operating system of the smartphone wakes up the sensors. However, this can result in constant late trip starts, ranging from one hundred to one thousand feet (ft) in driving distance before a trip gets recognized and the crash detection activated. However, since a large fraction of accidents happen shortly after vehicle trips start, many of these accidents remain undetected with these smartphone based software solutions.

Sensors of the smartphone can be utilized to generate data that is interpreted by algorithms (such as, but not limited to, artificial intelligence (AI) algorithms) to infer different events. The events can include, but are not limited to, identifying crashes, detecting certain driving behavior, identifying if the smartphone is in a vehicle, etc. Some examples are described in U.S. Pat. Nos. 11,350,237, 9,867,035, 9,333,946, and 8,989,952, which are hereby incorporated by reference in their entirety.

The present disclosure addresses some or all of these limitations by introducing systems and methods that improve the accuracy and timeliness of trip start detection, enabling earlier activation of telematics features and enhancing the overall reliability of vehicle telematics systems. The present disclosure describes systems and methods for determining operational modes, that facilitate activation and/or control of detection sensors and/or inference software, based on connection with a vehicle's communication system. A user mobile device can be configured to operate a plurality of different modes, depending on where the device is determined to be in a vehicle or out of the vehicle. In a particular mode, the device can be configured to enable pre-determined features or functions associated with a specific location and/or disabling other predetermined features of functions associated with a specific location. For example, the device can institute a suite of applications and turn off other applications. In a specific example, the identification of the vehicle can be used to place the device in a “vehicle mode” where the device is operated in a particular manner because it is determined to be in, or on, a vehicle. Examples discussed herein can provide improved detection of trip starts, which can facilitate earlier initiation of vehicle modes.

As used herein, the term “vehicle” encompasses a wide range of machines and transportation modes, including ground-based vehicles, aerial vehicles, and nautical vehicles. Further, the term “vehicle” is intended to cover machines and transportation modes in which a user is carried within or inside (such as within an enclosed or partially enclosed compartment), as well machines and transportation modes in which the user is carried on the vehicle but not inside an enclosed compartment (such as a motorcycle). Therefore, in one example, a vehicle includes at least a pair of wheels.

Accordingly, for the purposes of the present discussion, the term “vehicle mode” may be used interchangeably with “in-vehicle mode,” although it is understood that “in-vehicle” is not limited to enclosed passenger compartments or specific types of vehicles. The term “in-vehicle” includes scenarios where the user is carried on or within a vehicle, regardless of the vehicle's design or configuration. The described systems and methods are applicable to a variety of transportation contexts, including personal vehicles, commercial fleets, public transportation, and recreational vehicles.

As used herein, the term “trip” refers to a period of vehicle operation that begins at a start time, such as when a vehicle system is activated, and ends at an end time, such as when the vehicle system is deactivated. A trip typically starts when a vehicle is powered on, such as by turning the ignition or activating an equivalent system, after which the vehicle begins to move or is otherwise prepared for operation. The trip typically ends when the vehicle is powered off, parked, or otherwise ceases operation. A trip can also include one or more of a start location corresponding to the start time, an end location corresponding to the end time, a trip duration between the start and end times, and a trip distance between the start and end locations. A trip can also include various phases of vehicle activity, such as idling, acceleration, deceleration, and stationary periods, and can encompass a wide range of driving contexts, including personal, commercial, or shared vehicle use. For the purposes of telematics systems, a trip includes the period during which telematics data is actively collected, analyzed, and logged to monitor vehicle operations, driver behavior, and environmental conditions.

Mobile devices can include a wide variety of portable and/or wearable computing devices equipped with sensors, communication modules, and processing capabilities. Examples of mobile devices include, but are not limited to, smart devices such as smartphones, smart watches, smart glasses, tablets, fitness trackers, and the like. An example smart device can include cellular and/or satellite radiotelephone(s) with or without a display (text/graphical); Personal Communications System (PCS) terminal(s) that may combine a radiotelephone with data processing, facsimile and/or data communications capabilities; Personal Digital Assistant(s) (PDA) or other devices that can include a radio frequency transceiver and a pager, Internet/Intranet access, Web browser, organizer, calendar and/or a global positioning system (GPS) receiver; and/or conventional laptop (notebook) and/or palmtop (netbook) computer(s), tablet(s), or other appliance(s), which include a radio frequency transceiver. Smart devices can also include any radiating user device that may have time-varying or fixed geographic coordinates and/or may be portable, transportable, installed in a vehicle (aeronautical, maritime, or land-based) and/or situated and/or configured to operate locally and/or in a distributed fashion over one or more location(s).

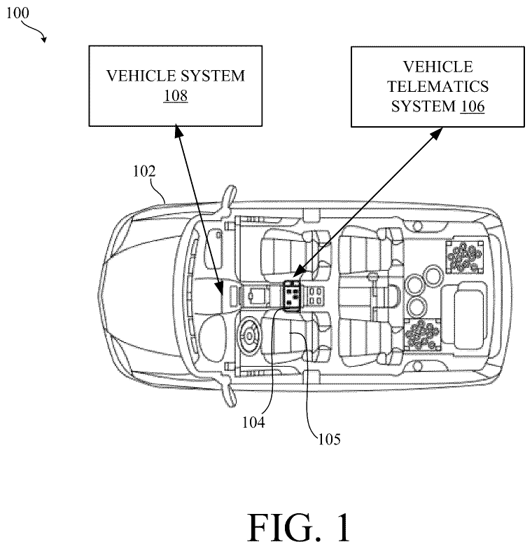

FIG. 1 illustrates a vehicle environment 100 including a vehicle 102 and a mobile device 104, such as a smartphone, of a user (not illustrated in FIG. 1) who may occupy a driver's seat 105 of vehicle 102. Mobile device 104 includes a vehicle telematics system 106 and vehicle 102 includes a vehicle system 108. Mobile device 104 is configured to send signals to and/or receive signals from vehicle system 108. Examples of vehicle system 108 include, but are not limited to, an automotive head unit, a safety/security system, a tire pressure monitoring system (TPMS), to name a few.

An example automotive head unit (also known as an infotainment system or car stereo) includes the central control interface for a vehicle's entertainment, information, and connectivity functions. Example functions include audio control, navigation, connectivity, vehicle settings and interfaces, and telematics and communication. The head unit can include vehicle audio components and can include a hardware interface including screens, buttons, and/or other controls for various integrated information and/or entertainment functions. As illustrated in FIG. 1, the head unit can be located in a central area of a dashboard or console and provide an integrated electronic package. The head unit provides a user interface for the vehicle's information and entertainment media components including, but not limited to, AM/FM radio, satellite radios, DVDs/CDs, cassette tapes, USB, GPS navigation, Bluetooth, Wi-Fi, etc.

For instance, a Bluetooth transmitter can be built into the head unit and support hands-free calling and/or audio streaming. Alternatively, or in addition, a Wi-Fi transmitter can support users connecting to an in-vehicle hotspot.

In some examples, the wireless access point(s) require a handshake protocol to connect mobile device 104. These protocols include a unique identifier to identify vehicle 102 to mobile device 104. For instance, Bluetooth and/or Wi-Fi communication channels can transmit a broadcast identifier (ID) of the vehicle system 108 (e.g., head unit). Mobile device 104 can use the identifier to uniquely determine that the mobile device 104 is within vehicle 102 identified by the identifier.

An example safety/security system includes a key fob proximity detection system having proximity sensors configured to detect a key fob within a certain range, and automatically unlocking the doors when the fob is nearby.

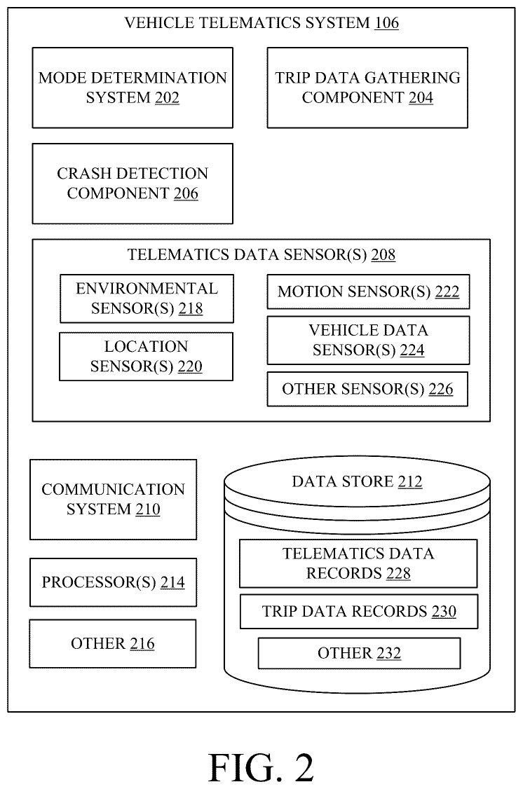

FIG. 2 is a block diagram of vehicle telematics system 106, in one example. As noted above, some or all of vehicle telematics system 106 can operate on mobile device 104. System 106 includes a mode determination system 202, a trip data gathering component 204, a crash detection component 206, one or more telematics data sensors 208, a communication system 210, a data store 212, one or more processors 214, and can include other items 216 as well.

Telematics data sensor(s) 208 are configured to generate sensor signals indicative of telematics data pertaining to vehicle 102, when mobile device 104 is used in or on vehicle 102. As used herein, “telematics data” refers to information collected, transmitted, and/or analyzed to monitor and manage vehicle operations, driver behavior, and/or environmental conditions. Telematics data can be generated by one or more of environmental sensors 218, location sensors 220, motion sensors 222, vehicle data sensors 224, and/or other sensors 226. The term “vehicle telematics data” is used herein to refer to telematics data pertaining to a vehicle, or vehicles, without regard to where the data is generated. That is, vehicle telematics data can be generated by mobile device 104 and/or vehicle 102.

Environmental sensor(s) 218 are configured to detect characteristics about the surroundings and external conditions of mobile device 104, and generate sensor signals indicative of those characteristics. Examples include, but are not limited to, acoustic sensors, temperature sensors, rain sensors, humidity sensors, air pressure sensors, road surface sensors, windspeed sensors, air quality sensors, to name a few.

Location sensor(s) 220 are configured to detect a geographical location of mobile device 104. Examples include, but are not limited to, a global positioning system (GPS), a dead reckoning system, a long-range navigation (LORAN) system, a cellular triangulation system, or a wide variety of other systems or sensors that provide an indication of the geographical location of mobile device 104.

Motion sensor(s) 222 are configured to detect one or more aspects of motion of mobile device 104. Examples of motion sensors include accelerometers, which measure changes in velocity or acceleration in one or more axes, and gyroscopes, which detect angular velocity and rotational motion. The sensors can provide detailed information about the movement and orientation of the mobile device. For instance, an accelerometer can detect sudden deceleration indicative of harsh braking, while a gyroscope can identify sharp turns or rollovers. Additionally, magnetometers can be used to determine directional orientation relative to the Earth's magnetic field, and vibration sensors can detect subtle oscillations or vibrations, such as those caused by engine idling. Further, data from location sensor(s) and/or motion sensor(s) 222 can be utilized to determine ground speed and/or the direction of travel in two or three dimensions.

Vehicle data sensor(s) 224 are configured to obtain vehicle data from vehicle 102, such as through wireless or wired communication with one or more vehicle systems. For example, the vehicle data can include, but is not limited to, vehicle speed, location, acceleration, braking patterns, engine status, fuel consumption, trip duration, to name a few. Further, the data can also indicate contextual information, such as driver identity or vehicle type.

The telematics data can be stored in data store 212 as telematics data records 228. Illustratively, data store 212 also stores trip data records 230, and can store other data as well, as indicated by block 232.

Mode determination system 202 is configured to determine an operational mode for system 106 based on information received from vehicle system 108. Examples are discussed in further detail below. Briefly, vehicle telematics system 106 is configured to operate in a plurality of different modes in which telematics functionality is activated at different levels. Activating different levels of telematics functionality can include one or more of activating a particular sensor, increasing a sampling rate of a particular sensor, and/or increasing a sampling precision of a particular sensor. In one example, system 202 switches between a first, low power mode and a second, high power mode depending on detection of a trip start condition.

Trip data gathering component 204 is configured to gather trip data, which can be stored as trip data records 230 in data store 212. In one example, trip data is gathered upon detection of a trip start condition, and includes some or all of the telematics data detected by sensors 208.

Communication system 210 is configured to communicate with vehicle system 108 through a wireless or wired connection. Communication system 210 can also communicate with a remote system, such as a remote server.

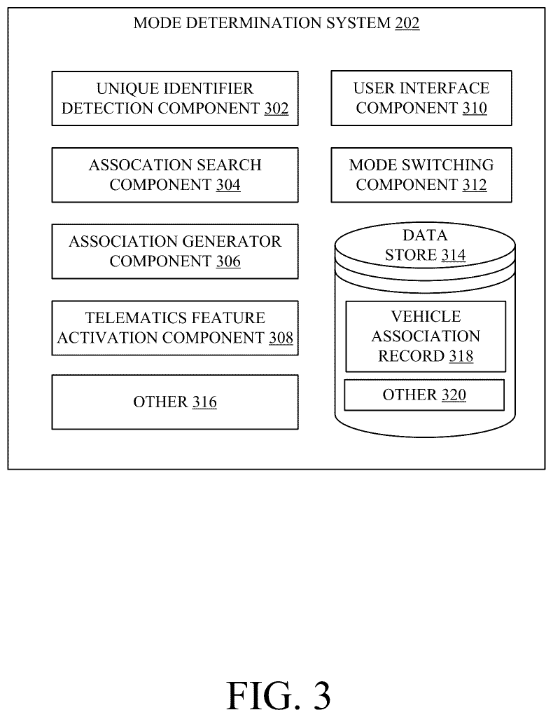

FIG. 3 is a block diagram of mode determination system 202, in one example. System 202 includes a unique identifier detection component 302, and association search component 304, and association generator component 306, a telematics feature activation component 308, a user interface component 310, a mode switching component 312, a data store 314, and can include other items 316 as well.

Unique identifier detection component 302 is configured to detect a unique identifier transmitted from vehicle 102. For example, the unique identifier can uniquely identify vehicle system 108, and thus be used to uniquely identify vehicle 102 from other vehicles that the user of mobile device 104 may drive or be a passenger in.

For sake of illustration, in one example vehicle system 108 includes a vehicle head unit that communicates with mobile device 104 via Bluetooth. The vehicle head unit includes a Bluetooth Head Unit ID, also known as a Bluetooth Device Address (“BD address”), that is a unique 48-bit identifier assigned to the Bluetooth device. The BD address is commonly represented as a 12-digit hexadecimal value, such as 00:11:22:33:FF:EE. In this way, each Bluetooth device has a unique ID, ensuring that devices can be individually identified. The BD address is used to manage connections and keep track of Bluetooth Low Energy (BLE) bonding. Bluetooth Low Energy (BLE) mode is a specialized operational state within the Bluetooth protocol designed to minimize power consumption while maintaining efficient wireless communication. In BLE mode, devices such as automotive head units or mobile devices can transmit and receive data using short bursts of communication, significantly reducing energy usage compared to traditional Bluetooth modes.

Association search component 304 is configured to search vehicle association records 318 stored in data store 314, for a given vehicle or vehicle system identified by the unique identifier. Vehicle association records 318 can be indexed by the unique identifier of the vehicle system 108, and store additional information, such as context information, about the vehicle.

Association generator component 306 is configured to generate new vehicle association records in data store 314. The generation of the new vehicle association records can be done automatically and/or through manual user input. For example, a user can be prompted through a user interface display to generate additional information to be stored in the vehicle association record. Data store 314 can store other items 320 as well.

Telematics feature activation component 308 is configured to activate and/or deactivate telematics features of system 106 based on mode switching by component 312. User interface component 310 is configured to generate user interface displays, rendered on mobile device 104, for interaction by the user.

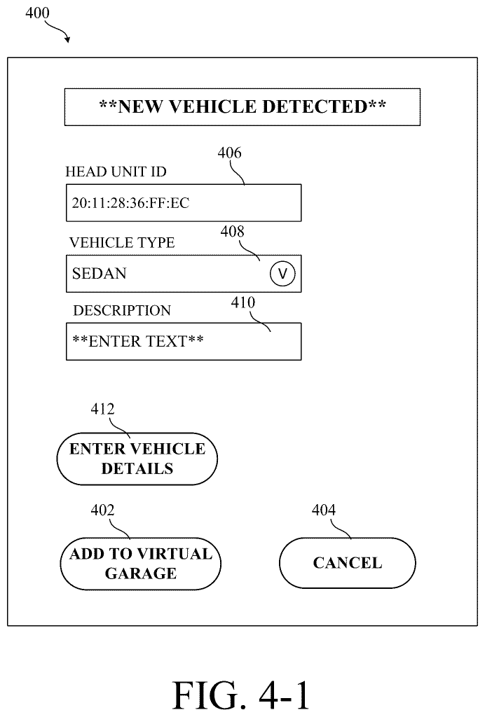

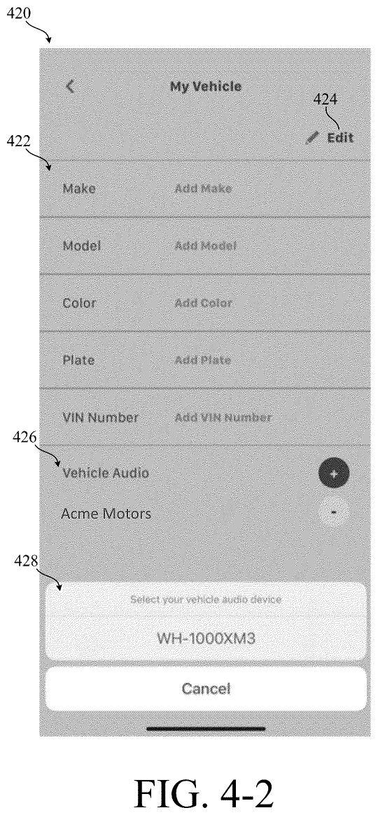

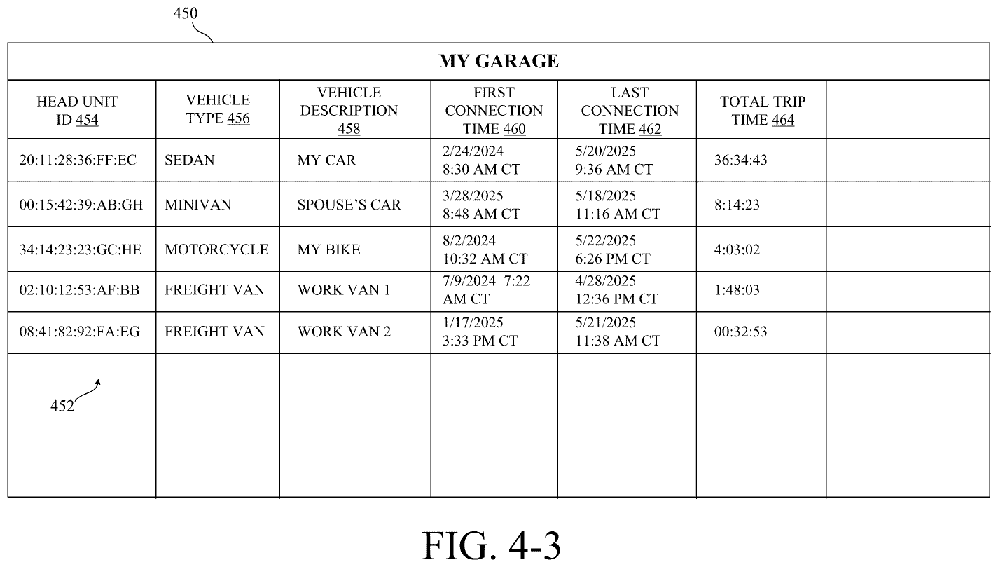

FIG. 4-1 illustrates one example of a user interface display 400 for generating a vehicle association record. As shown, display 400 indicates that a new vehicle has been detected, based on receipt of a unique identifier for which a vehicle association record has not been identified, and prompts the user as to whether the new vehicle should be associated with the mobile device. Illustratively, vehicles associated with the mobile device are stored in a virtual “garage” of the user. In this way, a user can store predefined associations with vehicles that the user frequently drives and/or is a passenger in. Display 400 includes one or more controls (e.g., add control 402 and a cancel control 404) that allow the user to selectively add the new vehicle to their virtual garage.

A unique identifier display element 406 displays the unique identifier received for the new vehicle. A vehicle type display element 408 displays the type of the new vehicle. The vehicle type can be determined automatically, such as based on information received from the vehicle system and/or by mapping the unique identifier to a particular vehicle type. Some examples of vehicle types include, but are not limited to, motorcycles, convertibles, sports cars, wagons, pickup trucks, minivans, sedans, coupes, vans, buses, sport utility vehicles (SUVs), electric vehicles, and semi-trailers.

Alternatively, or in addition, display element 408 can include an input control, such as a text box, a drop-down menu, or other user input mechanism, configured to receive user input manually select or defining the vehicle type. A description display element 410 can include an input control, such as a text box, configured to receive user input to specify a description of the new vehicle.

A vehicle details control 412 is actuatable to enter additional vehicle details, such as make, model, color, to name a few, for the vehicle to be added to the virtual garage. In one example, actuation of control 412 causes display of a pop-up window or other user interface display with input mechanism for entering the additional vehicle details.

FIG. 4-2 illustrates one example of a user interface display 420 for setting up a new vehicle in a vehicle association record. In one example, display 420 is automatically displayed in response to detection of a unique identifier from a vehicle system of the vehicle. In another example, display 420 is displayed in response to a user input, such as a user actuating control 412 shown in FIG. 4-1.

Display 420 includes a plurality of details fields 422 configured to receive and display various details of the vehicle. The details can be automatically populated based on the unique identifier and/or manually entered by the user. For example, a user can actuate edit control 424 to provide user input mechanisms, such as text entry boxes, drop-down menus, selection tools, etc. configured to receive user input.

A pairing control 426 is provided on display 420 and configured to initiate a pairing process with a vehicle system, such as the vehicle head unit. A display clement 428 shows the vehicle system(s) that are available for pairing. Element 428 facilitates user selection of the vehicle system to complete the pairing process.

FIG. 4-3 illustrates an example data structure 450 that stores a plurality of vehicle associations records 452 in a user's virtual garage. Data structure 450 includes a unique identifier (illustratively a head unit identifier) field 454, a vehicle type field 456, a vehicle description field 458, a first connection time field 460, a last connection time 462, a total trip time field 464, and can include other fields as well.

For each association record, unique identifier field 454 stores the unique identifier received from the vehicle system of the corresponding vehicle. Vehicle type field 456 stores an indication of the type of vehicle, which can be determined automatically and/or based on user input. Vehicle description field 458 stores a vehicle description, such as the description entered through description display element 410 shown in FIG. 4-1. First connection time field 460 stores an indication of an initial time at which the mobile device connected to the vehicle, such as when the user added the vehicle to the virtual garage through display 400 discussed above. Last connection time field 412 indicates the most recent time with which the mobile device connected to the vehicle, such as the last time the user drove or rode in the particular vehicle. Total trip time field 464 stores an indication of a total trip time during which the mobile device was connected to the vehicle.

It is noted that in at least some examples described herein, a “connection” between the mobile device and the vehicle does not require the establishment of authenticated or secure connection between the mobile device in the vehicle. For instance, in the case of Bluetooth communication, the connection does not require the completion of a pairing process between the mobile device and the vehicle. In this way, a trip start can be detected based on receipt of the unique identifier before and/or without pairing.

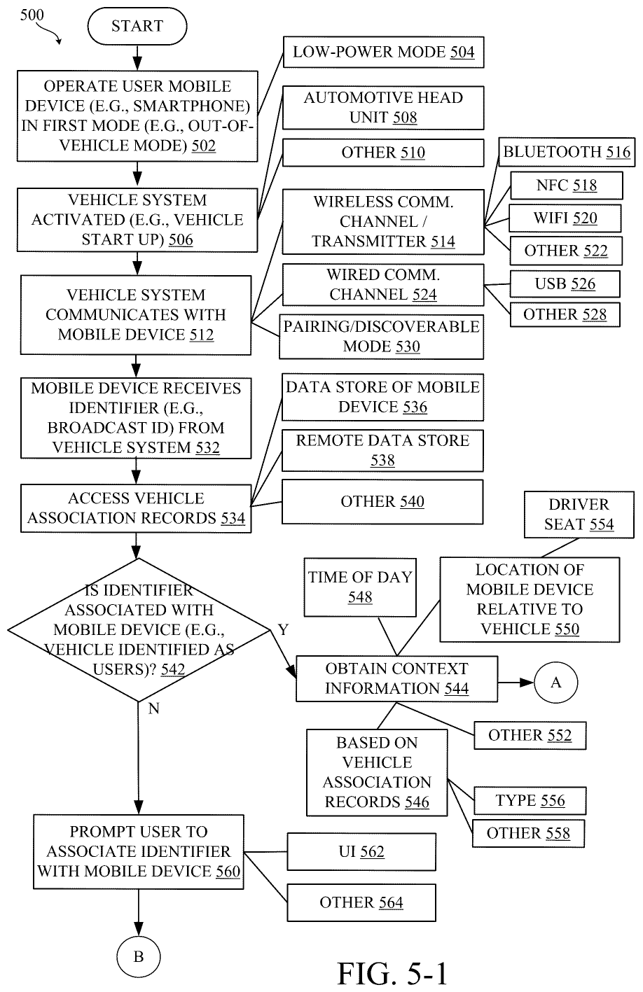

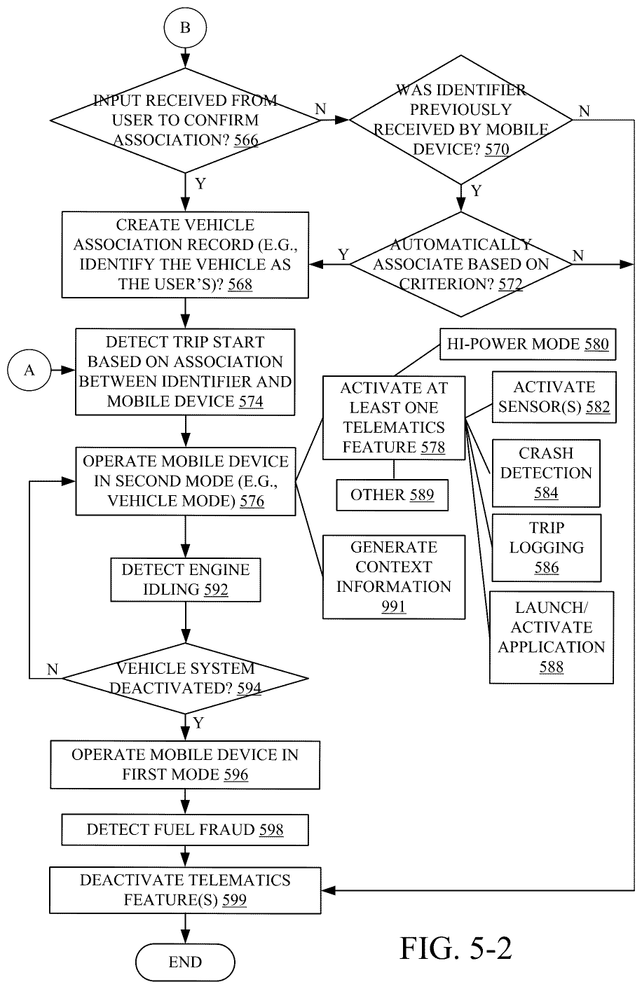

FIGS. 5-1 and 5-2 (collectively referred to as FIG. 5) provide a flow diagram illustrating an operation 500 of a vehicle telematics system, in one example. For sake of illustration, but not by limitation, FIG. 5 will be discussed in the context of FIGS. 1 and 2.

At block 502, mobile device 104 is operated in a first mode. The first mode is illustratively a mode in which mobile device 104 is determined to be out the vehicle, or at least some functions associated with an in-vehicle mode are not enabled. The first mode is a low-power mode as represented at block 504. In the low-power mode, sensors or other functionality on mobile device 104 can be deactivated and/or configured in a low precision state, since mobile device 104 is not considered to be in vehicle 102. For instance, sensors for crash detection can be disabled when mobile device 104 is in the out-of-vehicle mode. Alternatively, or in addition, crash detection sensors can be set to a low or reduced sampling frequency and/or precision, to conserve battery life of mobile device 104 when mobile device 104 is not in the in-vehicle mode.

At block 506, vehicle system 108 of vehicle 102 is activated, such as in response to start-up of vehicle 102 (e.g., the user inserting a key into the ignition of vehicle 102). In one example, vehicle system 108 includes an automotive head unit, as represented at block 508. The vehicle system can include other systems as well, as represented at block 510.

At block 512, vehicle system 108 communicates with mobile device 104. For instance, the communication can be through a wireless communication channel, represented at block 514, having a transmitter configured to transmit a broadcasted unique ID and facilitate wireless connection of mobile device 104 to the vehicle system. For example, the communication can include, but is not limited to, Bluetooth (block 516), near field communication (NFC) (block 518), Wi-Fi (block 520), or other types of communication channels, as represented at block 522.

The communication can also include a wired communication channel, represented at block 524. One example includes a universal serial bus (USB), as represented at block 526. Of course, other types of wired communication channels can be utilized as well, as represented at block 528.

In one example, as represented at block 530, the communication at block 512 occurs before or during operation of a pairing or discoverable mode in which one or more mobile device 104 and vehicle system 108 executes a process that establishes a secure wireless connection therebetween.

For sake of illustration, but not by limitation, performing the telematics operations without requiring pairing between mobile device 104 and vehicle system 108 offers benefits in terms of speed, convenience, and user experience. By detecting the system identifier broadcast by the vehicle system prior to establishing a secure pairing, the mobile device can promptly determine a vehicle trip start condition and activate telematics features without delays associated with the pairing process, which can ensure that functions, such as crash detection and trip logging, are enabled immediately when the vehicle system is activated, reducing the risk of missed events during the initial moments of a trip. Additionally, bypassing the need for pairing simplifies the system's operation, eliminating the need for user intervention to establish a connection, which is particularly advantageous in shared vehicle or fleet management scenarios. This also enhances compatibility across a wide range of vehicles and mobile devices, as the method relies on the broadcast of a unique identifier rather than a fully established connection. Furthermore, avoiding pairing reduces power consumption, as the mobile device can operate in a low-power mode while still detecting the system identifier, thereby conserving battery life. This streamlined approach improves the reliability and efficiency of telematics systems while maintaining a seamless and user-friendly experience.

At block 532, mobile device 104 receives a unique identifier. For example, one or both of wired or wireless channels can transmit a unique identifier of vehicle system 108 to mobile device 104 when the corresponding connection is made between mobile device 104 and head unit (e.g., a user connecting mobile device 104 to a head unit via Bluetooth, plugging mobile device 104 into a USB port of the head unit, etc.). In one example, the broadcast system is only active in vehicle 102 if the ignition is on, which can indicate that the driver is in the vehicle and, a trip is likely to start.

At block 534, vehicle association records are accessed to determine if any identifiers have previously been stored in association with mobile device 104. For example, the vehicle association records can be stored in a data store of mobile device 104 (block 536), in a remote data store (block 538), and/or elsewhere (block 540).

At block 542, the operation determines if the identifier, received at block 532, is already associated with the mobile device. In one example, block 542 includes determining whether the vehicle identifier, received at block 532, is already stored in the vehicle association records. In this way, based on matching of the broadcast identifier with the mobile device 104, an attribution of the individual person (user of the mobile device) to the specific broadcast identifier can be made. Also, since the specific mobile device is typically a personal device that is primarily used by only one person, and the mobile device is therefore highly personalized (e.g., contains personal data, is protected by various means like passwords, biometric identifiers, or other methods), it can be inferred that the mobile device is used by a particular driver, as that driver is also identified as the mobile device owner.

At block 544, context information is obtained. The context information can be obtained from the vehicle association record identified by the unique identifier (block 546). Further, the context information can be obtained based on the time of day (block 548), based on the location of mobile device 104 relative to vehicle 102 (block 550), or otherwise (block 552).

At block 550, the operation can generate an indication as to whether the user is likely located in the driver seat (block 554), for example by determining the location of mobile device 104 within vehicle 102. In this way, the operation can determine if mobile device 104 is used by the driver versus a passenger during a given trip. Examples of block 554 are described in U.S. Pat. Nos. 11,350,237, 9,867,035, 9,333,946, and 8,989,952, incorporated herein by reference in their entirety.

The context information obtained from the vehicle association record can include information such as the type of vehicle (block 556), or other information (block 558).

If the identifier is not already associated with the mobile device (e.g., the received identifier is not currently stored in the vehicle association records), operation proceeds to block 560 in which the user is prompted to associate the identifier with the mobile device 104. Block 560 can include rendering a prompt on a user interface (block 562) of the mobile device, such as the user interface display shown in FIG. 4-1. Of course, the user can be prompted in other ways as well, as represented at block 564.

At block 566, input is received from the user to confirm (or reject) the association. If the user confirms the association, operation proceeds to block 568 in which the identifier is stored, for example in vehicle association records on mobile device 104. Storage of the identifier can operate to identify the vehicle, corresponding to the identifier, as belonging to the user of the mobile device.

If the association is rejected by the user at block 566, operation proceeds to block 570 which determines whether the identifier was received by the mobile device one or more times previously. For example, mobile device 104 can store a log of identifier previously received from vehicle(s), even though an explicit association has not been made between the user and the vehicle. In this case, operation proceeds to block 572 in which an automatic association can be made based on one or more trip criterion. In this way, if a particular identifier is recognized by mobile device 104 over several trips, an automatic association can be made between the identifier and the user of the mobile device, without requiring user confirmation. Examples of the criterion include, but are not limited to, a number of trips, a frequency of trips, an amount of time between trips, the type of the trips, the date/time of the trips, and/or other criterion or combination of criteria.

At block 574, a trip start condition is detected based on the association between the received identifier and mobile device 104. In response to detection of the trip start condition, at block 576, mobile device 104 is operated in a second mode, that is different from the first mode. Illustratively, the second mode is a vehicle mode in which some features or functions are activated or otherwise enhanced for increased detection precision.

For example, at least one telematics feature is activated at block 578. In one example, the second mode is referred to as a high-power mode 580 in that it results in a higher power consumption as compared to the low-power mode. For instance, the vehicle mode can include activating one or more telematics data sensors, enhancing GPS location detection, increasing sampling frequencies and/or sensing precision, generally represented at block 582.

Block 578 can also include activating or modifying software algorithms for crash detection scheme (block 584). Briefly, in one example, a vehicle crash is detected using a mobile device equipped with sensors and communication capabilities. A crash detection system leverages data from the mobile device's accelerometer, gyroscope, and other telematics sensors to identify sudden changes in motion or impact forces indicative of a collision. The system employs algorithms to analyze sensor data in real-time, distinguishing crash events from non-crash scenarios, such as abrupt braking or device drops. Upon detecting a crash, the system initiates emergency protocols, which can include sending alerts to emergency services, notifying designated contacts, and providing the vehicle's location using GPS data. Some or all of the crash detection features are configured to operate autonomously, minimizing reliance on user intervention. Additionally, the crash detection system can integrate with external telematics platforms or insurance systems to facilitate first notice of loss (FNOL) and streamline claims processing.

Block 578 can also include activating trip logging at block 586. One example of trip logging involves collecting and storing telematics data generated by the mobile device's sensors, such as GPS location, accelerometer readings, gyroscope data, and environmental conditions. For example, the system can record the start and end times of the trip, the total distance traveled, and the route taken using GPS data. Additionally, accelerometer and gyroscope data can be used to identify driving behaviors such as harsh braking, rapid acceleration, or sharp turns, which are logged as trip events. Environmental sensors, such as acoustic or temperature sensors, can provide contextual data, such as road noise or weather conditions during the trip. The logged data can be stored locally on the mobile device or transmitted to a remote server for further analysis, such as generating driver behavior reports, calculating fuel efficiency, or identifying patterns for usage-based insurance models. Trip logging also enables fleet managers to monitor vehicle utilization, optimize routes, and schedule preventative maintenance based on vehicle usage patterns. By capturing detailed and structured trip data, the system enhances the accuracy and utility of telematics applications across consumer, fleet, and insurance contexts.

Block 578 can also include launching and/or changing an active/inactive state of a telematics application on the mobile device. For example, block 578 involves transitioning the application from a passive or inactive state, called sometimes ‘sleep mode’ in Android or iOS systems, to an active state on the mobile device. Upon detecting a trip start condition, the system can automatically elevate the telematics application to an active processing state and if warranted to the forefront of the device's interface, ensuring that the user is protected by safety features and has immediate access to other features and information. For example, the application can display a dashboard with real-time trip data, such as current speed, route mapping, and driving behavior alerts. This transition allows the user to interact with the application directly, enabling functionalities such as initiating navigation, viewing vehicle diagnostics, or accessing emergency contact options in the event of a crash.

In addition to enhancing user accessibility, waking the application up and bringing it to the forefront can activate specific telematics features that require user engagement or monitoring. For instance, the application may display alerts for unsafe driving behaviors, such as harsh braking or speeding, or provide notifications about upcoming maintenance needs based on vehicle diagnostics.

Of course other telematics feature(s) can be activated as well, as represented at block 589.

At block 591, context information is generated based on the telematics data. For example, the type of vehicle can be inferred and stored in the vehicle association record based on the telematics data. For instance, the system can determine that the vehicle is likely to be a motorcycle based on acceleration data, acoustic data, etc.

At block 592, an engine idling event can be detected. In one example, upon detecting the trip start, even though little or no GPS movement has been detected, a correlation with vibrations measured by sensors of mobile device 104 can create an inference that vehicle 102 is running (e.g., an internal combustion engine of vehicle 102 is on) but has not moved (i.e., vehicle 104 is in a state of “engine idling”). Engine idling can be a large problem in carbon emissions, especially in large commercial fleets, resulting in significant fuel costs. Block 592 can detect and generate alerts to instances of engine idling that meet a threshold criterion.

At block 594, the operation determines whether the vehicle system 108 has been deactivated, such as by the user turning off vehicle 102. For example, deactivation of a head unit can be detected based on the identifier no longer being received by mobile device 104. If it is determined that the vehicle system has been deactivated, operation can proceed to block 596 in which the mobile device is returned to the first mode, to reduce power consumption based on a trip end detection.

At block 598, instances of “fuel fraud” can be detected. Block 598 includes, in one example, associating the particular user of mobile device 104 to specific location coordinates (GPS coordinates) that have been identified as a “trip end” due to deactivation of the vehicle system. This information can be provided to an administrator, fleet manager, or other user to ensure that the user of mobile device 104 has properly accounted for a fuel transaction. For example, if a fuel card transaction occurs, but vehicle 102 does not show a trip end at or near the location of the fuel card transaction, then an instance of fuel fraud can be determined to be likely, and this can be reported to the administrator and/or fleet manager.

At block 599, telematics service communication can be deactivated in response to detection of the trip end. In this way, transmission of telematics information outside of the occurrence of the actual trip can be minimized if not eliminated, thereby increasing data privacy and/or minimizing unnecessary data transmission.

For sake of illustration, but not by limitation, in prior approaches, trip start detection and subsequent crash detection may not activate until the vehicle has traveled a significant distance and/or reached a significant speed (e.g., more than a thousand feet, more than twenty-five miles per hour, etc.). In this way, these prior approaches may not detect crashes that occur before the thresholds are met. Illustratively, a low-speed collision at the beginning of a trip (e.g., a user pulling out of a parking space) will go undetected.

Conversely, the present mode determination system can facilitate activation of mobile device sensors and/or detection inference software when a broadcast identifier from the vehicle unit is recognized by mobile device 104 allowing mobile device 104 to detect a trip start at or more closely conforming to a true beginning point of a drive of vehicle 102, which can facilitate a more immediate detection of accidents or other events after the vehicle is in motion.

It can thus be seen that the present disclosure describes technology for controlling device operation modes to improve the timing of vehicle trip starts and detection of events of interest. Examples of the disclosed technology can facilitate improved attribution of vehicle, trip, and/or driver without any need for extra devices being installed in the vehicle. Further, the technology can improve crash detection recognition and timeliness, which can save lives and also improve FNOL, overcoming drawbacks of smartphone-based telematics.

It should also be noted that the different examples described herein can be combined in different ways. That is, parts of one or more examples can be combined with parts of one or more other examples. All of this is contemplated herein.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

As used herein, if a description includes “one or more of” or “at least one of” followed by a list of example features with a conjunction “or” between the penultimate example feature and the last example feature, then this is to be read such that (1) one exemplary embodiment includes at least one of or one or more of each feature of the listed features, (2) another exemplary embodiment includes at least one of or one or more of only one feature of the listed features, and (3) another exemplary embodiment includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the exemplary embodiment includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of” followed by a list of example features with a conjunction “and” between the penultimate example feature and the last example feature.

The present discussion has mentioned processors and/or servers. In one embodiment, the processors and/or servers include computer processors with associated memory and timing circuitry, not separately shown. They are functional parts of the systems or devices to which they belong and are activated by and facilitate the functionality of the other components or items in those systems.

Also, a number of user interface displays have been discussed. They can take a wide variety of different forms and can have a wide variety of different user actuated input mechanisms disposed thereon. For instance, the user actuated input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

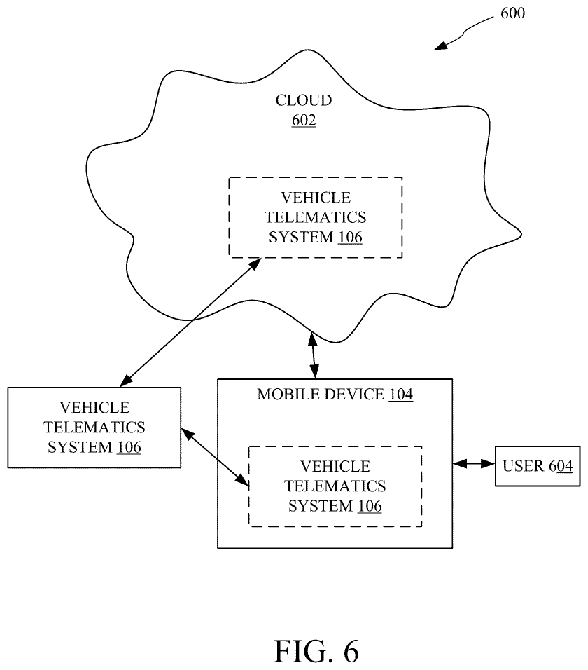

FIG. 6 is a block diagram of telematics system 106, shown in FIG. 1, deployed in a remote server architecture 600. In an example, remote server architecture 600 can provide computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network, and they can be accessed through a web browser or any other computing component. Software or components shown in FIG. 1 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the example shown in FIG. 6, some items are similar to those shown in FIG. 1 and they are similarly numbered. FIG. 6 shows that some or all of mode determination system 202 can be located at a remote server location, such as a cloud computing environment 602 (also referred to as cloud 602).

FIG. 6 also depicts another example of a remote server architecture. FIG. 6 shows that it is also contemplated that some elements of FIG. 1 are disposed at remote server location 602 while others are not. By way of example, some or all of vehicle telematics system 106 can be disposed at a location separate from remote server location 602 and accessed through the remote server location 602. Also, as shown in FIG. 6, components and functions of system 602 can be distributed between mobile device 104 and cloud 602.

Regardless of where the components are located, the components can be accessed directly by mobile device 104, through a network (either a wide area network or a local area network), they can be hosted at a remote site by a service, or they can be provided as a service, or accessed by a connection service that resides in a remote location.

It will also be noted that the elements of FIG. 1, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

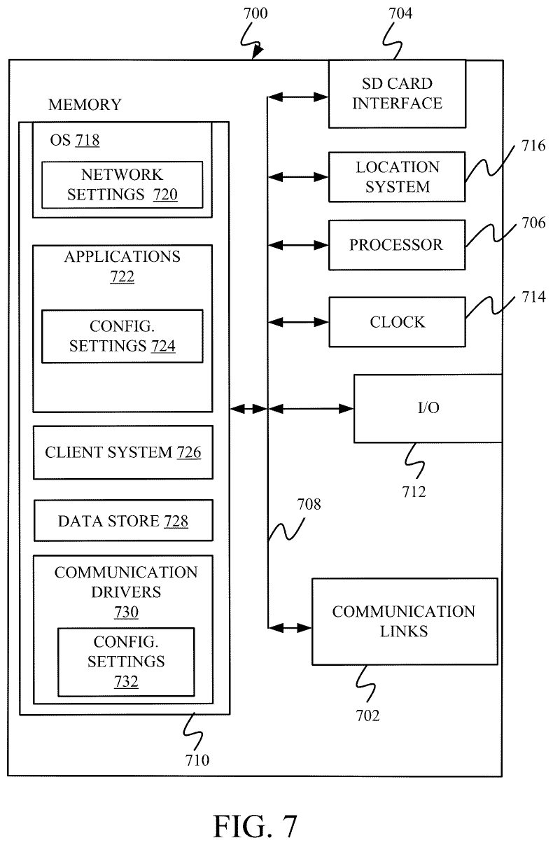

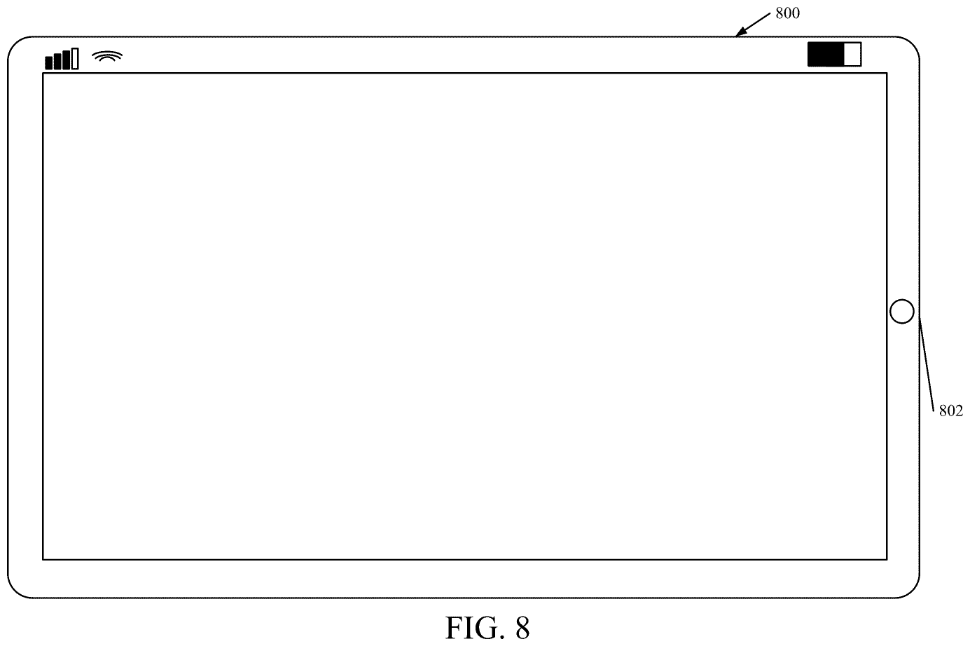

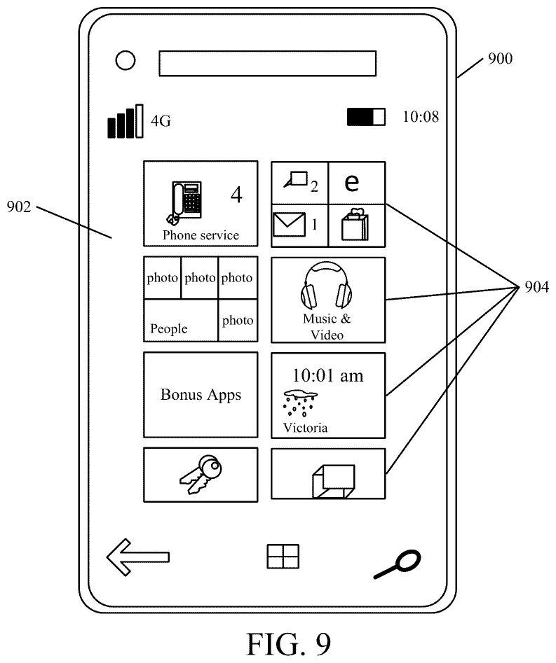

FIG. 7 is a simplified block diagram of one illustrative example of a handheld or mobile computing device, in which the present system (or parts of it) can be deployed. FIGS. 8-9 are examples of handheld or mobile devices.

FIG. 7 provides a general block diagram of the components of a device 700 that can run some components shown in FIG. 1, that interacts with them, or both. In device 700, a communications link 702 is provided that allows the handheld device to communicate with other computing devices and under some embodiments provides a channel for receiving information automatically, such as by scanning. Examples of communications link 702 include allowing communication though one or more communication protocols, such as wireless services used to provide cellular access to a network, as well as protocols that provide local wireless connections to networks.

In other examples, applications can be received on a removable Secure Digital (SD) card that is connected to an interface 704. Interface 704 and communications link 702 communicate with a processor 706 (which can also embody processors or servers from previous FIGS.) along a bus 708 that is also connected to memory 710 and input/output (I/O) components 712, as well as clock 714 and location system 716.

I/O components 712, in one example, are provided to facilitate input and output operations. I/O components 712 for various embodiments of the device 700 can include input components such as buttons, touch sensors, optical sensors, microphones, touch screens, proximity sensors, accelerometers, orientation sensors and output components such as a display device, a speaker, and or a printer port. Other types of I/O components 712 can be used as well.

Clock 714 illustratively comprises a real time clock component that outputs a time and date. It can also, illustratively, provide timing functions for processor 706.

Location system 716 illustratively includes a component that outputs a current geographical location of device 700. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 710 stores operating system 718, network settings 720, applications 722, application configuration settings 724, a client system 726, data store 728, communication drivers 730, and communication configuration settings 732. Memory 710 can include all types of tangible volatile and non-volatile computer-readable memory devices. Memory 710 can also include computer storage media (described below). Memory 710 stores computer readable instructions that, when executed by processor 706, cause the processor to perform computer-implemented steps or functions according to the instructions. Processor 706 can be activated by other components to facilitate their functionality as well.

FIG. 8 shows one example in which the mobile device is a tablet computer 800. In FIG. 8, computer 800 is shown with user interface display screen 802. Screen 802 can be a touch screen or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 800 can also illustratively receive voice inputs as well.

FIG. 9 shows that the device can be a smartphone 900. Smartphone 900 has a touch sensitive display 902 that displays icons or tiles or other user input mechanisms 904. Mechanisms 604 can be used by a user to run applications, make calls, perform data transfer operations, etc. In general, smartphone 900 is built on a mobile operating system and offers more advanced computing capability and connectivity than a feature phone. Note that other forms of the mobile device are possible.

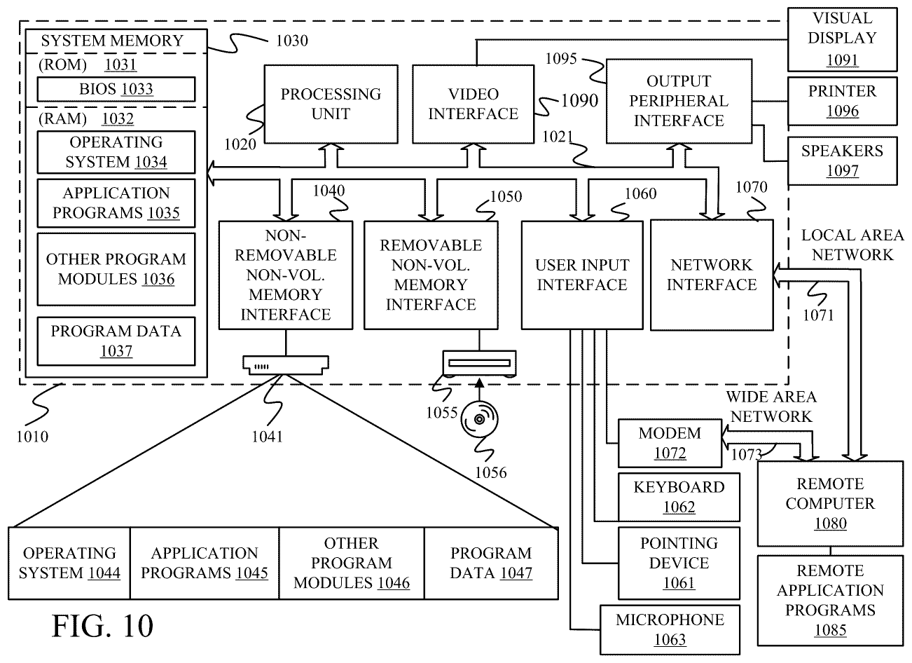

FIG. 10 is one example of a computing environment in which elements of FIG. 1, or parts of it, (for example) can be deployed. With reference to FIG. 10, an example system for implementing some embodiments includes a computing device in the form of a computer 1010. Components of computer 1010 may include, but are not limited to, a processing unit 1020 (which can comprise processors or servers from previous FIGS.), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. Memory and programs described with respect to FIG. I can be deployed in corresponding portions of FIG. 10.

Computer 1010 typically includes a variety of computer readable media. Computer readable media can be any available media that can be accessed by computer 1010 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 1030 includes computer storage media in the form of volatile and/or nonvolatile memory such as read only memory (ROM) 1031 and random-access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable volatile/nonvolatile computer storage media. By way of example only, FIG. 10 illustrates a hard disk drive 1041 that reads from or writes to non-removable, nonvolatile magnetic media, an optical disk drive 1055, and nonvolatile optical disk 1056. The hard disk drive 1041 is typically connected to the system bus 1021 through a non-removable memory interface such as interface 1040, and optical disk drive 1055 is typically connected to the system bus 1021 by a removable memory interface, such as interface 1050.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037.

A user may enter commands and information into the computer 1010 through input devices such as a keyboard 1062, a microphone 1063, and a pointing device 1061, such as a mouse, trackball or touch pad. Other input devices (not shown) may include a joystick, game pad, satellite dish, scanner, or the like. These and other input devices are often connected to the processing unit 1020 through a user input interface 1060 that is coupled to the system bus but may be connected by other interface and bus structures. A visual display 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 is operated in a networked environment using logical connections (such as a local area network—LAN, or wide area network—WAN or a controller area network—CAN) to one or more remote computers, such as a remote computer 1080.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. In a networked environment, program modules may be stored in a remote memory storage device. FIG. 10 illustrates, for example, that remote application programs 1085 can reside on remote computer 1080.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather. the specific features and acts mentioned above are disclosed as example forms of implementing the claims.

What is claimed is:

1. A method performed by a mobile device, the method comprising:
receiving, by a communication receiver of the mobile device over a communication channel, a system identifier that uniquely identifies a vehicle system of a vehicle;
detecting a vehicle trip start condition based on a pre-defined association between the system identifier and the mobile device;
based on detecting the vehicle trip start condition, operating the mobile device in a vehicle mode comprising activating at least one telematics feature; and
detecting vehicle telematics data generated by a telematics data sensor.

2. The method of claim 1, wherein the mobile device comprises a smartphone.

3. The method of claim 1, and further comprising detecting the pre-defined association by accessing a vehicle association record that stores the system identifier.

4. The method of claim 3, wherein the vehicle association record includes a vehicle type field that identifies a type of the vehicle.

5. The method of claim 3, and further comprising obtaining context information from the vehicle association record, wherein the at least one telematics feature is activated based on the context information.

6. The method of claim 5, wherein the at least one telematics feature performs a telematics function using the context information.

7. The method of claim 6, wherein the telematics function performs crash detection using the context information.

8. The method of claim 1, wherein the communication channel comprises a wireless communication channel, wherein the mobile device is configured to execute a pairing process that establishes a secure wireless connection between the vehicle system and the mobile device.

9. The method of claim 8, wherein the system identifier is received by the mobile device prior to the pairing process.

10. The method of claim 9, wherein the wireless communication channel comprises Bluetooth, and the system identifier is received by the mobile device in a Bluetooth low power mode.

11. The method of claim 1, wherein the mobile device comprises the telematics data sensor configured to generate a sensor signal indicative of the vehicle telematics data, the vehicle telematics data comprising at least one of:
an environment of the mobile device,
a geographic position of the mobile device, or
a movement of the mobile device.

12. The method of claim 1, wherein activating the at least one telematics feature comprises at least one of:
activating the telematics data sensor;
increasing a sampling rate of the telematics data sensor; or
increasing a sampling precision of the telematics data sensor.

13. The method of claim 11, wherein activating the at least one telematics feature comprises configuring a crash detection algorithm to detect a crash event based on the sensor signal.

14. The method of claim 11, wherein the at least one telematics feature comprises a trip logging feature configured to log trip events, after the vehicle trip start condition, based on the vehicle telematics data.

15. The method of claim 1, wherein the at least one telematics feature comprises at least one of:
a driver behavior monitoring feature;
a fuel fraud detection feature; or
an engine idling detection feature.

16. The method of claim 1, wherein the mobile device includes an application, and activating the at least one telematics feature comprises at least one of:
launching the application on the mobile device; or
transitioning the application on the mobile device from an inactive state to an active state.

17. A computer-readable media having computer-readable instructions stored thereon, wherein the computer-readable instructions, when executed by a computer, cause the computer to:
detect operation of a vehicle system of a vehicle based on receiving, by the computer over a communication channel, a system identifier that uniquely identifies the vehicle system;
detect a vehicle trip start condition based on a pre-defined association between the system identifier and the computer;
based on detecting the vehicle trip start condition, operating the computer in a vehicle mode comprising activating at least one telematics feature; and
detect vehicle telematics data generated by a telematics data sensor.

18. The computer-readable media of claim 17, wherein the at least one telematics feature comprises at least one of:
the telematics data sensor;
a crash detection algorithm;
a trip logging feature;
a driver behavior monitoring feature;
a fuel fraud detection feature; or
an engine idling detection feature.

19. A mobile computing device comprising:
a telematics data sensor;
a communication system configured to wirelessly communicate with a vehicle system of a vehicle;
a pairing component configured to perform a pairing of the mobile computing device with the vehicle system to establish a secure wireless connection between the vehicle system and the mobile computing device;
at least one processor; and
memory storing instructions executable by the at least one processor, wherein the instructions, when executed, cause the mobile computing device to:
prior to the pairing of the mobile computing device with the vehicle system, receive, by the communication system from the vehicle system, a system identifier that uniquely identifies the vehicle system;
determine a vehicle trip start condition based on the system identifier; and
operate in a vehicle mode based on the vehicle trip start condition, wherein the vehicle mode activates at least one telematics feature.

20. The mobile computing device of claim 19, wherein the at least one telematics feature comprises at least one of:
the telematics data sensor;
a crash detection algorithm;
a trip logging feature;
a driver behavior monitoring feature;
a fuel fraud detection feature; or
an engine idling detection feature.
